(19) United States
(12) Patent Application Publication
(10) Pub. No.: US 2011/0288729 A1
(43) Pub. Date: Nov. 24, 2011

(54) Automatic Adjustment of a Turf Care Implement

(75) Inventor: Christopher Phillip McKinney, Clover, SC (US)

(73) Assignee: TEXTRON INC., Providence, RI (US)

(21) Appl. No.: 12/784,592

(22) Filed: May 21, 2010

(51) Int. Cl. A01D 34/835; G06F 19/00; A01D 34/01

(52) U.S. Cl. 701/50; 56/238; 56/10.2 E

(57) ABSTRACT

A turf care device having an implement for performing a turf care function. The turf care device has a module for determining its position relative to the turf. The turf care implement is controlled based upon the position of the turf care device.

### FIELD

The present disclosure relates to a turf maintenance vehicle.

### BACKGROUND

This section provides background information related to the present disclosure which is not necessarily prior art.

Turf maintenance vehicles (i.e., grounds keeping vehicles) are used for grounds keeping purposes on golf courses, parks, and other locations. Ride-on or riding mowers, for instance, typically include a power delivery system (e.g. an internal combustion engine, batteries, etc.), a ground traction system that receives power from the power delivery system, and a cutting unit or other turf care implement. Walk-behind mowers may be similarly configured and include or omit a powered ground traction system.

In various instances, a turf maintenance vehicle may include a cutting unit assembly which is used to cut the turf of a golf green. On a typical golf course, the golf green is cut to the lowest height of any turf on the golf course. A golf course green is bordered by a higher cut of turf, typically referred to as the collar. Beyond the collar, many golf greens are surrounded by a higher cut of turf, referred to as rough, sand traps, water, or other golf course features.

During the process of cutting a golf green, the operator causes the mower to traverse the green from edge to edge. When approaching the collar, the operator preferably raises the cutting unit assembly so that the cutting unit, which is set at a relatively low height of cut, does not cut the turf of the collar, thereby scalping the collar. When the collar is scalped, grass typically cut in the range of between 0.125 and 0.380 inches is cut substantially shorter than its typical height. Scalped turf of a golf green collar takes time to recover when cut to golf green height and can turn brown and die. Similar conditions can also apply when transitioning from cutting a fairway (typically at a height of 0.380 to 1.00 inches) to the intermediate cut (typically at a height of 0.50 to 2.00 inches) to the rough (typically at a height of 1.5 to 6.0 inches).

### SUMMARY

This section provides a general summary of the disclosure, and is not a comprehensive disclosure of its full scope or all of its features.

A turf maintenance apparatus includes a turf maintenance implement having a first position where the implement is disposed in contact with the turf and a second position where the turf maintenance implement is spaced away from the turf. A position determining module receives a location signal that enables the determination of the position of the turf maintenance apparatus relative to a first area of the turf. The position determining module generates a control signal to displace the turf maintenance implement from the first position to the second position when the turf maintenance apparatus is in proximity to the first area of the turf.

A turf maintenance vehicle includes a frame and a turf maintenance implement supported by the frame and having a first position where the implement is disposed in contact with the turf and a second position where the turf maintenance implement is disposed away from the turf. A lift mechanism displaces the turf maintenance implement from the first position to the second position. A ground traction system includes a plurality of wheels supporting the frame and a power delivery system that delivers power to at least one of the turf maintenance implement or the ground traction system. A location sensor determines a location of the turf maintenance implement relative to a predetermined area. The location sensor generates a signal, and the lift mechanism displaces the turf maintenance implement from the first position to the second position when the turf maintenance implement is in proximity to the predetermined area.

A turf maintenance vehicle includes a frame and a ground traction system having a plurality of wheels supporting the frame. A turf maintenance implement is supported by the frame and configured to be translated between a first position and a second position. A power delivery system delivers power to at least one of the turf maintenance implement or the ground traction system. A lift mechanism displaces the turf maintenance implement between the first position and the second position. A location sensor detects a proximity signal and generates a location signal that varies in accordance with a proximity of the turf maintenance implement to a first predetermined area. A controller receives the location signal and communicates with the lift mechanism to cause the lift mechanism to displace the turf maintenance implement in response to the location signal.

A turf maintenance vehicle includes a frame and a ground traction system including a plurality of wheels supporting the frame. A first cutting unit assembly is supported by the frame for cutting turf at least at first predetermined height and configured to be displaced between a first operating position and a second operating position. A first lift mechanism displaces the first cutting unit assembly between the first and second operating positions. A power delivery system delivers power to at least one of the first lift mechanism, first cutting unit assembly, or the ground traction system. A first location sensor is responsive to a proximity signal and generates a first location signal that varies in accordance with a first proximity of the first cutting unit assembly to a border of the turf. A controller receives the first location signal and communicates with the first lift mechanism to cause the first lift mechanism to displace the cutting unit assembly between the first and second operating positions in response to the first location signal.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a mower arranged in accordance with various aspects of the disclosure;

FIG. 2 is a configuration of a typical golf green;

FIG. 3 is a block diagram of a system for automatically adjusting the position of a turf care implement according to various aspects of the disclosure;

FIG. 4 is a block diagram of a system for automatically adjusting the position of a turf care implement according to various aspects of the disclosure;

FIG. 5 is a flow chart detailing the process for automatically controlling a turf care implement;

FIG. 6 is a configuration of a typical golf hole;

FIGS. 7A and 7B are positioning systems arranged in accordance with various aspects of the disclosure.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

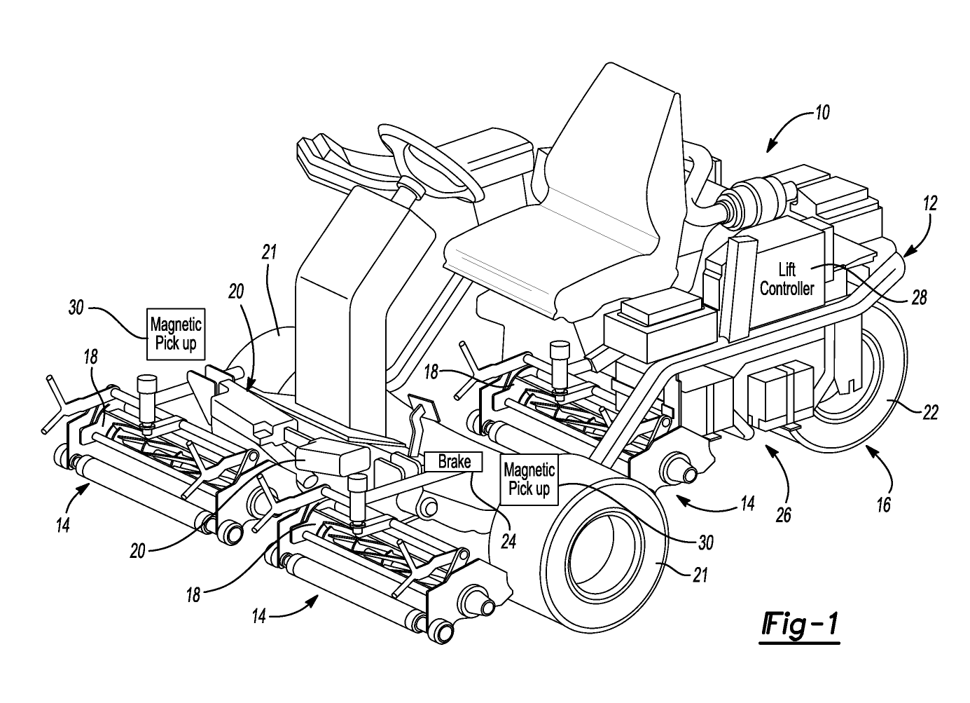

Referring initially FIG. 1, a turf maintenance vehicle (i.e., a grounds keeping vehicle), such as a mower 10 is illustrated. In the embodiment shown, mower 10 is a riding mower that generally includes a frame 12, turf maintenance implement assemblies 14, and a ground traction system generally indicated at 16. It will be understood by one skilled in the art that the teachings herein are applicable to any suitable turf maintenance vehicle, including, by way of non-limiting example, mowers, vertical mowers, spikers, groomers, sand rakes, aerators, utility vehicles, and other turf maintenance equipment. One skilled in the art will further recognize that the teachings herein are applicable to turf maintenance vehicles of both a riding, stand behind, and walk-behind variety.

Turf maintenance implement assemblies 14 are supported by the frame 12 and can be of any suitable type for turf or golf course maintenance purposes. In some aspects, a turf maintenance implement assembly 14 can include a cutting unit 18, shown herein as a reel cutter for cutting grass or for other turf maintenance operations. Turf maintenance implement assemblies 14 are raised and lowered by a respective lift mechanism 20. It will be appreciated that a turf maintenance implement assembly 14 can be any suitable turf maintenance implement, including, for instance, reel, rotary, and flail cutting implements, grooming implements, raking implements, aerating implements, and other turf maintenance implements. In various embodiments, turf maintenance assembly implements 14 may include one or a plurality of implements, such as a pair of forward turf maintenance implement assemblies 14 and a rear or center turf maintenance implement assembly 14.

Ground traction system 16 supports frame 12 and provides propulsion and steering for mower 10. In various embodiments, ground traction system 16 includes a plurality of front wheels 21, which are driven to propel mower 10, and a rear wheel 22, which can turn relative to frame 12 to thereby steer mower 10. The ground traction system 16 also includes a brake, schematically indicated at 24. The brake 24 can be of any suitable type for reducing the ground speed of mower 10.

Mower 10 includes a power delivery system generally indicated at 26. Power delivery system 26 can be of any suitable type for generating power and transmitting power to the ground traction system 16 and/or the turf maintenance implement assemblies 14. For example, power delivery system 26 can include an internal combustion engine for generating mechanical or electrical energy, a plurality of batteries, or a combination of the two. As such, power delivery system 26 generates and delivers power to ground traction system 16 to thereby propel the mower. In various embodiments, power delivery system 26 delivers electrical or hydraulic power to the various components of turf maintenance implement assemblies 14 to operate turf maintenance assemblies 14.

In various embodiments, power delivery system 26 also includes a lift controller, schematically indicated at 28. Lift controller 28 electrically communicates with position sensors, shown schematically in FIG. 1 as magnetic pick up 30. In various embodiments, magnetic pick up 30 may be associated with each of a turf maintenance implement assembly 14. In other embodiments, magnetic pick up 30 can be a single position sensor associated with all turf maintenance implement assemblies 14.

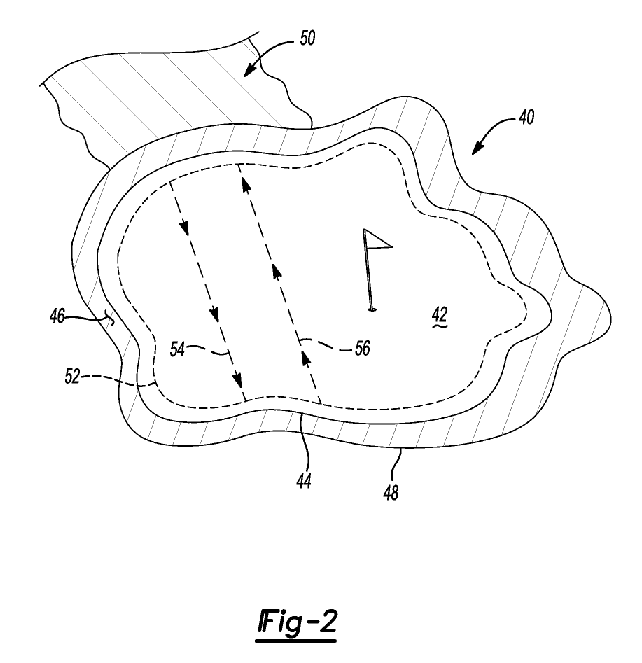

FIG. 2 depicts a typical configuration of a golf green complex 40. Golf green complex 40 includes a golf green 42 which could be formed of any of a various number of turf mixes and is typically cut within the height range of 0.125 to 0.380 inches. The edges of golf green 42 are bordered by a boundary 44 that defines an inner edge of golf green collar 46. Collar 46 can include turf mixes similar to or different than golf green 42. Collar 46 includes an outer boundary 48. Outer boundary 48 can border various golf features, including taller grass, defined as rough, bunkers, water, rocks, or other various golf course features. By way of example, rough 50 may include grass mixtures similar to or different than one or both of golf green 42 or collar 46. The height of the rough can vary widely depending on the golf course, green committee, or superintendent preference but can often be found to be within the range of 1.5 to 6.0 inches.

Regardless of the turf selection or actual height of cut of golf green 42, collar 46, or rough 50, a typical golf course defines these turf features by the relative height of cut of the turf. A golf green is typically cut fairly short and tight to provide a true roll of a golf ball. A golf green collar is typically cut higher than the golf green yet sufficiently low so that suitable contact occurs between a golf club and a golf ball lying on the collar. Rough 50, on the other hand, is typically cut higher, though the relative heights can vary, so that a golf ball can sit down in the rough. When a golf ball sits down in the rough, grass typically interferes with the contact between the golf ball and the golf club.

Turf on a golf green 42 is cut at a certain height. If collar 46 is cut at the height of golf green 42, damage in the form of scalping can result to the collar 46. Likewise, for similar reasons, it is generally not desirable to cut the rough 50 at the same height as the collar 46.

Also shown in FIG. 2., buried beneath golf green 42, is a conductor or pick up wire 52 which interacts with magnetic pick up 30 to provide warning of the approaching boundary 44 as mower 10 traverses golf green 42 in the direction of boundary 44. According to various embodiments, mower 10 includes an automatic lift mechanism. The automatic lift mechanism raises turf maintenance implement assemblies 14 as mower 10 and its turf maintenance implement assemblies 14 approach boundary 44 between golf green 42 and collar 46, thereby protecting the height of cut of collar 46.

In operation, as mower 10 traverses golf green 42, as shown at paths 54 and 56, magnetic pick ups 30 interact with pick up wire 52 to signal that mower 10 is approaching boundary 44. Upon detection of pick up wire 52, magnetic pick ups 30 send signals to lift controller 28 which causes lift mechanism 20 to raise respective turf maintenance implement assemblies 14. Pick up wire 52 is arranged relative to boundary 44 so as to allow lift controller 28 to cause lift mechanism 20 to raise turf maintenance implement assembly 14 prior to a respective turf maintenance implement assembly 14 traversing collar 46, thereby reducing the risk of scalping.

The operator then turns mower 10 to traverse golf green 42 along a path in a direction opposite path 54, such as along path 56. As mower 10 traverses path 56 and approaches boundary 44, pick up wire 52 interacts with magnetic pick ups 30 to cause the respective turf maintenance implement assemblies 14 to be raised as mower 10 approaches boundary 44. Lift controller 28 detects the proximity to boundary 44 as indicated by pick up wire 52 and causes each lift mechanism 20 to raise a respective turf maintenance implement 14. As mower 10 turns from path 54 to follow path 56, the operator determines when to cause lift mechanism 20 to lower each respective turf maintenance implement 14 so as to enable cutting of the turf of golf green 42. The lowering operation may be similarly automated using an opposite process described above.

FIG. 3 depicts a block diagram of a lift control system 60 implemented on turf mower 10 according to various embodiments. In lift control system 60, a trio of sensors 62a, 62b, 62c generate proximity signals input to lift controller 64. Each sensor 62a, 62b, 62c corresponds to a particular respective turf maintenance implement 14 of mower 10. FIG. 3 also depicts three cutting units 68a, 68b, 68c associated with a respective sensor 62a, 62b, 62c, which also correspond to a respective turf maintenance implement 14. One skilled in the art will recognize that proximity sensors may be provided so as to yield a one to one or one to many correspondence between sensors and corresponding turf maintenance implements assemblies 14.

Controller 64 receives location signals from respective sensors 62a, 62b, 62c. The location signal indicates detection of pick up wire 52. Upon receiving a location signal, lift controller 64 generates a signal to respective lift mechanisms 66a, 66b, 66c. Lift mechanisms 66a, 66b, 66c are mechanically connected to respective cutting units 68a, 68b, 68c. When lift controller 64 receives a location signal from respective sensors 62a, 62b, 62c, indicating that a respective cutting unit 68a, 68b, 68c is approaching boundary 44, lift controller electrically communicates with lift mechanisms 66a, 66b, 66c to generate respective lift signals. The lift signals cause respective lift mechanisms 66a, 66b, 66c to displace respective cutting units 68a, 68b, 68c to a raised position.

Lift controller 64 is also configured to receive signals from an operator control panel 70 indicating that a selected cutting unit should be raised or lowered. More particularly, the operator utilizes control panel 70 to cause lift mechanisms 66a, 66b, 66c to raise or lower in response to activation of respective switches 1, 2, or 3 of control panel 70. Control panel 70 also includes a switch A for causing all of lift mechanisms 66a, 66b, 66c to operate in unison to simultaneously raise or lower respective cutting units 68a, 68b, 68c.

In various embodiments, the operator can utilize switch A on control panel 70 to command that all cutting units 68a, 68b, 68c displace to the down position. In various embodiments, this causes forward cutting units to drop initially. A center cutting unit, such as shown in mower 10 of FIG. 1, is then lowered in accordance with a speed and/or distance traveled by mower 10. Center cutting unit thus lowers to engage the turf of golf green 42 shortly after moving from over the collar 46 to over the golf green 42.

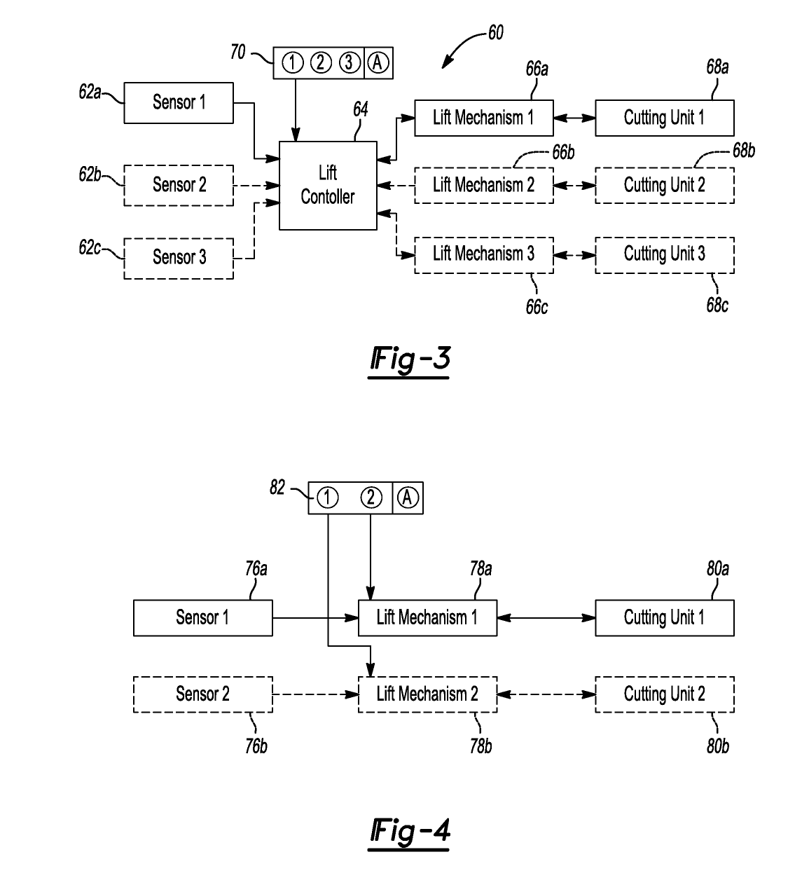

In various embodiments, each proximity sensor provides a proximity signal directly to a corresponding lift mechanism to operate corresponding lift mechanism. In FIG. 4, a pair of sensors 76a, 76b generate proximity signals similarly to that described above with respect to FIGS. 2 and 3. One skilled in the art will recognize that while only two sensors 76a, 76b are shown in FIG. 4, the principles described herein will apply to one or more sensor/lift mechanism/cutting unit combinations. Sensors 76a, 76b detect signals that enable locating respective cutting units 80a, 80b relative to the height of cut or other boundary. Sensors 76a, 76b provide signals to respectively lift mechanisms 78a, 78b. Lift mechanisms 78a, 78b are configured with circuitry sufficient to process the received signals received from sensors 76a, 76b. Lift mechanisms 78a, 78b generate control signals to each of respective cutting units 80a, 80b to displace cutting units 80a, 80b between a lowered and raised position. The operator can lower cutting units 80a, 80b from a raised position to a lowered position by operating switches 1, 2 of operator control panel 82. Operator control panel 82 also includes a switch A for simultaneously controlling a raise or lower operation of respective cutting units 80a, 80b similarly as described above.

One skilled in the art will further recognize that in various embodiments, a single sensor can control multiple cutting units. By way of non-limiting example, with reference to FIG. 3, various embodiments could omit sensors 62b, 62c so that only sensor 62a generates a proximity signal to lift controller 64. Lift controller 64 processes the signal from proximity sensor 62a and generates a plurality of signals to each of lift mechanisms 66a, 66b, 66c. In such a configuration, lift controller 64 can time the signals to each of cutting units 68a, 68b, 68c so that each is raised at approximately the same distance from boundary 44. For example, a center cutting unit would be raised at a predetermined time after a front cutting. The timing can vary in accordance with the longitudinal distance between cutting assemblies of mower 10 with the speed of the mower 10.

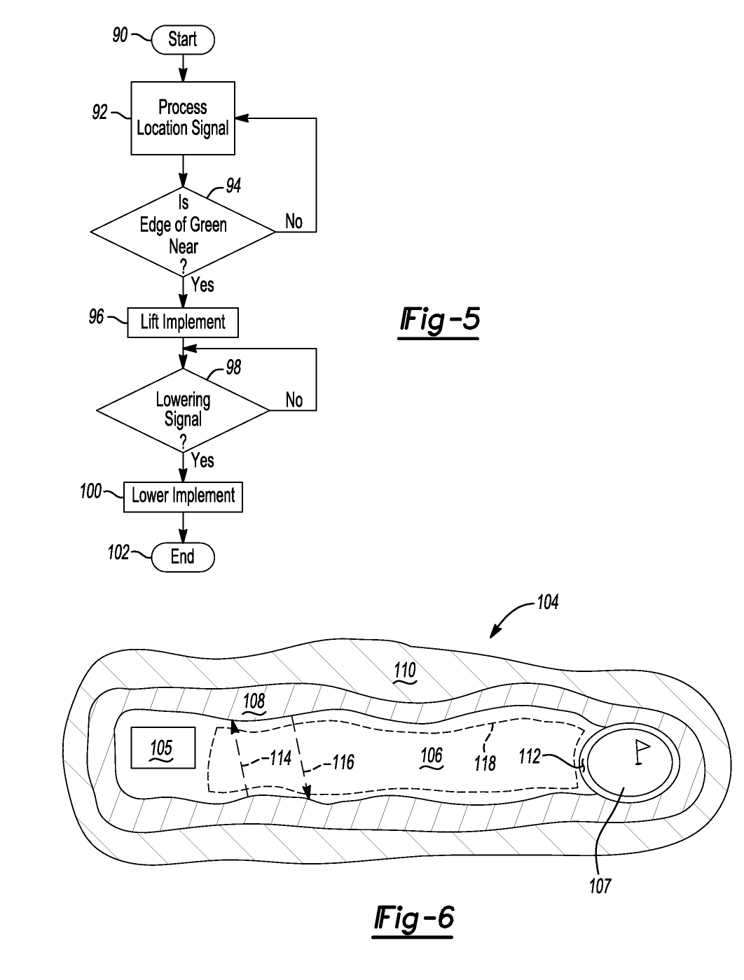

FIG. 5 is a flow diagram of the process for controlling the automated lift controller 28. Control begins at start block 90 and proceeds to block 92. At block 92, the system processes one or more location signals, which in various embodiments is output from one or more location sensors. Control proceeds to block 94. At block 94, a determination is made whether a cutting unit is near a height of cut boundary. If not, control proceeds back to block 92 where the system continues to process one or more location signals received from one or more sensors. If it is determined that a respective cutting unit is in proximity to a height of cut boundary, control proceeds to block 96. At block 96, a signal or signals are sent to one or a plurality of a lift mechanism to raise the respective cutting unit. Control then proceeds to block 98 which determines whether a lowering signal has been received, whether manually from the operator or through use of proximity sensors which determine the location of cutting unit with respect to a height of cut boundary. If no lowering signal has yet been received, control proceeds back to block 98. If a lowering signal has been received, control proceeds to block 100. At block 100, a signal is sent to one or a plurality of lift mechanism to cause the cutting units to lower to a cutting position. Control then proceeds to block 102.

FIG. 6 depicts golf hole 104. Golf hole 104 includes a tee box 105, a fairway 106, and a golf green 107. One skilled in the art will recognize that tee box 105, fairway 106, and golf green 107 may all be formed of different turf mixes and are typically cut to different heights. Golf hole 104 also includes an intermediate cut 108 disposed between fairway 106 and rough 110. Golf hole 104 further includes a collar 112 disposed around golf green 107. One skilled in the art will also recognize that golf hole 104 could also include various other features typically found on a golf course, including water hazards, sand bunkers, grass bunkers, and rock features. One skilled in the art will further recognize that intermediate cut 108 in various embodiments can be formed of a turf mixture different than fairway 106 and rough 110. The turf of intermediate cut 108 is typically cut to a height greater than fairway 106 but less than the height of cut of rough 110.

Golf hole 104 demonstrates other applications of a turf mower configured similarly to turf mower 10 of FIG. 1. In particular, with respect to cutting fairway 106, mower 10 can traverse a path 114 from one edge of fairway 104 to another edge of fairway 104. As the mower 10 approaches the edge of fairway 104 along path 114, the cutting units can be raised similarly as described above. By way of example, as mower 10 approaches the edge of fairway 104 along path 114, proximity sensors 62a, 62b, 62c can detect the approaching pick up wire 118 and communicate a proximity signal to lift controller 64, similarly as described above. The operator would then turn, having completed the cut of fairway 106 along path 114, and return along path 116. The process is repeated as mower 10 approaches intermediate cut 108 along path 116.

One skilled in the art will recognize that the principles described herein can further apply to causing lifting or adjustment of mower height to cut grass at a different height as a mower crosses a boundary between intermediate cut 108 and rough 110, by way of non-limiting example. One skilled in the art will recognize that to achieve such a configuration, mower 10 may be modified to include cutting units for suitably cutting two different heights. For example, one position may be for cutting fairway 106, and a second position may be for cutting intermediate cut 108, a third position may be for cutting rough 110.

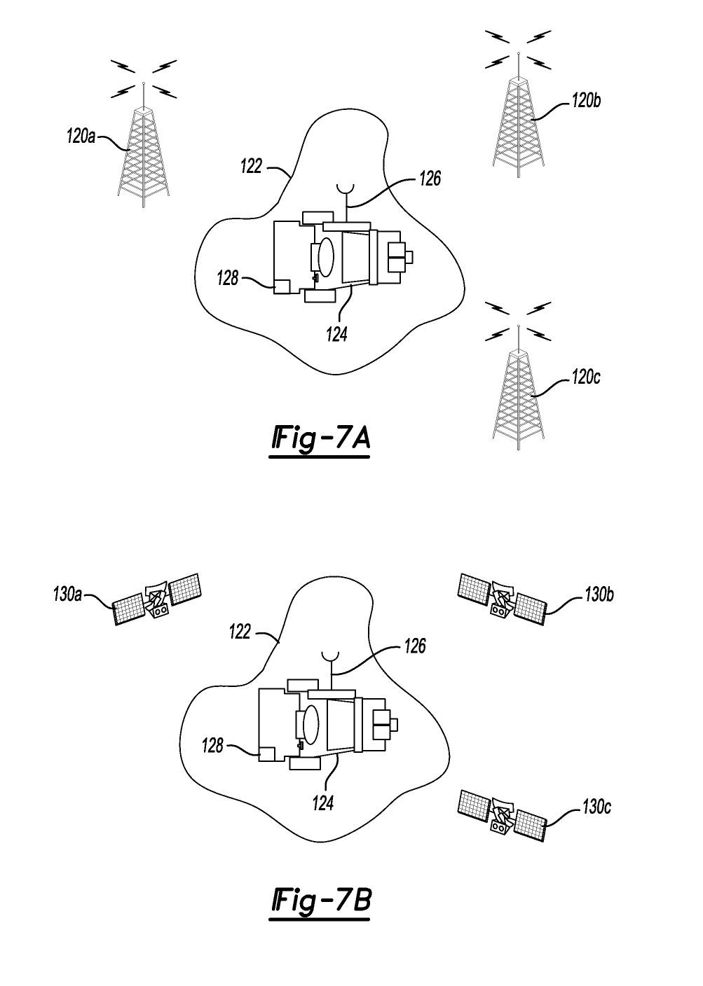

FIG. 7 depicts alternate approaches to locating a turf maintenance vehicle on a golf green or other areas of a golf course. In FIG. 7A, base stations 120a, 120b 120c can be disposed about the golf course 122. Turf maintenance vehicle 124, shown in block diagram form, includes an antenna 126 to detect transmissions from one or a number of base stations 120a, 120b, 120c. Turf maintenance vehicle 124 includes a processor to triangulate its position within golf course 122 by analyzing the timing of signals arriving from base stations 120a, 120b, 120c. Such triangulation is known to those skilled in the art. Turf maintenance vehicle 124 may include a detailed map of golf course 122 stored in electronic memory. Processing means can determine the position of turf maintenance vehicle 124 on golf course 122 and its path of travel. Based on the location and direction of travel of mower 10, it can be determined whether to raise one or more cutting units of mower. Turf maintenance vehicle 124 can include a lift control system 128 to cause turf maintenance implement assemblies 14 to be raised when in proximity to the border of features on the golf course where turf maintenance implement assemblies 14 must be raised or lowered. FIG. 7B is configured similarly to FIG. 7A, except the position of turf maintenance vehicle 124 is triangulated in accordance with satellites 130a, 130b, 130c.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A turf maintenance apparatus comprising:
a turf maintenance implement having a first position where the implement is disposed in contact with the turf and a second position where the turf maintenance implement is spaced away from the turf; and
a position determining module, the position determining module receiving a location signal that enables the determination of the position of the turf maintenance apparatus relative to a first area of the turf;
wherein the position determining module generates a control signal to displace the turf maintenance implement from the first position to the second position when the turf maintenance apparatus is in proximity to the first area of the turf.

2. The turf maintenance apparatus of claim 1 wherein the turf maintenance apparatus is at least one of a mower, spiker, or aerator.

3. The turf maintenance apparatus of claim 1 wherein the location signal is generated when the turf maintenance implement is in proximity to the first area.

4. The turf maintenance apparatus of claim 1 further comprising:
a second turf maintenance implement positionable in the first position and the second position;
wherein the position determining module generates a control signal to displace the turf maintenance implement from the first position to the second position when the turf maintenance apparatus is in proximity to a second area of the turf.

5. The turf maintenance apparatus of claim 4 wherein the first and second areas are any boundaries of a height of cut.

6. The turf maintenance apparatus of claim 1 further comprising a proximity sensor, the proximity sensor generating the location signal when the turf maintenance implement is in proximity to the first area.

7. The turf maintenance apparatus of claim 1 the proximity sensor detects proximity of a signal that indicates the turf maintenance implement is in proximity to the first area of the turf.

8. The turf maintenance apparatus of claim 7 wherein the proximity signal is a magnetic signal.

9. The turf maintenance apparatus of claim 1 further comprising a lift mechanism responsive to the control signal.

10. The turf maintenance apparatus of claim 1 wherein the first area is a boundary of an area of turf.

11. A turf maintenance vehicle comprising:
a frame;
a turf maintenance implement supported by the frame and having a first position where the implement is disposed in contact with the turf and a second position where the turf maintenance implement is disposed away from the turf;
a lift mechanism for displacing the turf maintenance implement from the first position to the second position;
a ground traction system including a plurality of wheels supporting the frame;
a power delivery system that delivers power to at least one of the turf maintenance implement or the ground traction system;
a location sensor for determining a location of the turf maintenance implement relative to a predetermined area;
wherein the location sensor generates a signal, and the lift mechanism displaces the turf maintenance implement from the first position to the second position when the turf maintenance implement is in proximity to the predetermined area.

12. The turf maintenance vehicle of claim 11 wherein the turf maintenance implement is at least one of a turf cutting unit, a spiker, or an aerator.

13. The turf maintenance vehicle of claim 11 wherein the location sensor determines the location or the turf maintenance implement relative to a proximity marker located beneath a top surface of the turf.

14. The turf maintenance vehicle of claim 11 further comprising a conductor for indicating the predetermined area, and the location sensor is magnetically response to the conductor.

15. A turf maintenance vehicle comprising:
a frame;
a ground traction system including a plurality of wheels supporting the frame;
a turf maintenance implement supported by the frame and configured to be translated between a first position and a second position;
a power delivery system that delivers power to at least one of the turf maintenance implement or the ground traction system;
a lift mechanism for displacing the turf maintenance implement between the first position and the second position;
a location sensor for detecting a proximity signal and generating a location signal that varies in accordance with a proximity of the turf maintenance implement to a first predetermined area; and
a controller receiving the location signal, the controller communicating with the lift mechanism to cause the lift mechanism to displace the turf maintenance implement in response to the location signal.

16. The turf maintenance vehicle of claim 15 wherein the turf maintenance implement is at least one of a cutting unit, an aerator, or a spiker.

17. The turf maintenance vehicle of claim 15 wherein the location sensor is responsive to a proximity marker located under a top surface of the turf in proximity to the first area.

18. The turf maintenance vehicle of claim 15 wherein the location sensor is responsive to a magnetic field.

19. The turf maintenance vehicle of claim 15 wherein the first position is away from the turf and the second position is in contact with the turf.

20. The turf maintenance vehicle of claim 15 wherein the turf maintenance vehicle is one of a walking or a riding mower.

21. A turf maintenance vehicle comprising:
a frame;
a ground traction system including a plurality of wheels supporting the frame;
a first cutting unit assembly supported by the frame for cutting turf at a first predetermined height and configured to be displaced between a first operating position and a second operating position;
a first lift mechanism for displacing the first cutting unit assembly between the first and second operating positions;
a power delivery system that delivers power to at least one of the first lift mechanism, first cutting unit assembly, or the ground traction system;
a first location sensor responsive to a proximity signal and generating a first location signal that varies in accordance with a first proximity of the first cutting unit assembly to a border of the turf; and
a controller receiving the first location signal, the controller communicating with the first lift mechanism to cause the first lift mechanism to displace the cutting unit assembly between the first and second operating positions in response to the first location signal.

22. The turf maintenance vehicle of claim 21 further comprising:
a second cutting unit assembly supported by the frame for cutting turf at the at least the first predetermined height of cut and configured to be displaced between the first operating position and the second operating position;
a second lift mechanism for displacing the cutting unit assembly between the first operating position and the second operating position;
a second location sensor responsive to a proximity signal and generating a second location signal that varies in accordance with a second proximity of the second cutting unit assembly to the border of the turf;
wherein the controller receives the second location signal and communicates with the second lift mechanism to cause the second lift mechanism to displace the second cutting unit assembly in response to the second location signal.

23. The turf maintenance vehicle of claim 22 wherein the first and second location sensors are responsive to a proximity marker located under a top surface of the turf in proximity to a border of the turf at a first predetermined height.

24. The turf maintenance vehicle of claim 22 wherein the first and second location sensors are responsive to a magnetic field.

25. The turf maintenance vehicle of claim 22 wherein the first operating position is a cutting position at the first predetermined height of cut.

26. The turf maintenance vehicle of claim 22 wherein the second operating position is a cutting position at a second predetermined height of cut.

27. The turf maintenance vehicle of claim 22 wherein the turf maintenance implement is one of a walking or a riding mower.

28. The turf maintenance vehicle of claim 22 wherein the first location sensor is responsive to a signal that enables triangulation of the location of the vehicle.
